(19) United States
(12) Patent Application Publication
(10) Pub. No.: US 2022/0372398 A1
(43) Pub. Date: Nov. 24, 2022

(54) High Alkaline High Foam Cleaners with Controlled Foam Life

(71) Applicant: Fluid Energy Group Ltd., Calgary (CA)

(72) Inventors: Markus WEISSENBERGER, Calgary (CA); Elsayed ABDELFATAH, Calgary (CA)

(21) Appl. No.: 17/740,787

(22) Filed: May 10, 2022

(30) Foreign Application Priority Data
May 14, 2021 (CA) 3120132

(51) Int. Cl. C11D 1/83; C11D 3/00; C11D 3/33

(52) U.S. Cl. CPC C11D 1/83; C11D 3/0026; C11D 3/33

(57) ABSTRACT

A caustic composition for cleaning apparatus, said composition comprising: a caustic component; a first low foaming anionic surfactant; a second nonionic surfactant; and a foam controlling agent comprising an amino acid. Methods of using such compositions are also disclosed.

### CROSS REFERENCE TO RELATED APPLICATIONS

This application claims the benefit of and priority to Canadian Patent Application No. 3,120,132, filed May 14, 2021. The entire specification and figures of the above-referenced application are hereby incorporated, in their entirety by reference.

### FIELD OF THE INVENTION

The present invention is directed to novel composition for use in the cleaning of pipes, equipment, and open vessels used in food, dairy and or beverage processing, more specifically in a caustic composition for such use.

### BACKGROUND OF THE INVENTION

Generally, the quality of a cleaner is associated with its ability to produce a lot of foam. However, for industrial cleaning purposes, long-life foams (a foam which takes a long period of time to subside) can be undesirable as the foam would stay for long time which lengthens the duration of the cleaning process and reduce hours of production. Hence, formulations that have high foamability but also controlled foam life are necessary. For open vessel cleaning in the food and beverage plants, formulations having shorter foam life are more desirable. Formulations with high reduction of contact angles and controlled foam life were developed for hard surface cleaning.

Hard surface cleaning compositions are well known and are deployed in a variety of applications, and are utilized for cleaning and disinfecting processing, packaging, manufacturing and transfer equipment in a variety of industrial processing plants. Conventionally, alkaline cleaners, acidic cleaners, bactericides, etc. have been utilized for both cleaning-in-place (CIP cleaning) and cleaning-out-of-place (COP cleaning) applications for a long time.

In the manufacture of foods and beverages, hard surfaces commonly become contaminated with organic residues including carbohydrates, proteins, fats, and other soils as well as inorganic residues typically referred to as scale. Such residues can arise from the manufacture of both liquid and solid foodstuffs. Carbohydrate residues, such as cellulosics, monosaccharides, disaccharides, oligosaccharides, starches, gums and other complex materials, when dried, can form tough, hard to remove residues. This is even more true when such carbohydrates are mixed with other soil components such as proteins, enzymes, fats, oils and others. The removal of such organic residues can cause significant difficulties to the operators of the establishments concerned. On the other hand, inorganic scales which are precipitated from hard water used in the cleaning process can only be dissolved in highly acidic cleaner or alkaline formulations with high concentration of chelating agents.

Cleaning-In-Place (CIP) cleaning methods are a specific cleaning regimen adapted for removing soils from the internal components of tanks, lines, pumps and other process equipment used for processing typically liquid product streams such as beverages, milk, juices, etc. CIP cleaning involves passing cleaning solutions through the system without dismantling any system components. The minimum clean-in-place technique involves passing the cleaning solution through the equipment and then resuming normal processing. Any product contaminated by cleaning composition residue can be discarded.

On the other hand, Cleaning-Out-of-Place (COP) methods involve the dismantling of parts and thorough cleaning, most often times by using a foaming composition and using a spray nozzle-type application. Compositions used for COP are applied by spraying and are used on open vessels and removed pipes and other equipment. Such COP compositions need to have a good foaming ability.

In general, COP methods involve a first rinse, the application of the cleaning solutions, a second rinse with potable water followed by resumed operations. The process can also include any other contacting step in which a rinse, acidic or basic functional fluid, solvent or other cleaning component such as hot water, cold water, etc. can be contacted with the equipment at any step during the process.

It has also become important for cleaning solutions or compositions to be formulated in such a way as to have less impact on the environment (to be “green”) and provide increased safety for transportation, storage and the personnel handling them. One way in which this is encouraged is through a program of the United States Environmental Protection Agency, known as the Design for the Environment Program (“DfE”). DfE certifies “green” cleaning products through the Safer Product Labeling Program.

U.S. Pat. No. 8,398,781 B2 teaches a method of cleaning equipment such as heat exchangers, evaporators, tanks and other industrial equipment using clean-in-place procedures and a pre-treatment solution prior to the conventional CIP cleaning process. The pre-treatment step improves the degree of softening of the soil, and thus facilitates its removal. The pre-treatment solution can be a strong acidic solution, a strong alkaline solution, or comprise a penetrant. It is stated that a preferred strong acidic solution is an acid peroxide solution. According to the patent, in some embodiments, the pre-treatment may include no strong alkali or acid ingredient; rather, the penetrant provides acceptable levels of pre-treatment.

German patent application DE1995141646 teaches a method for cleaning dairy equipment. It is stated that the invention also relates to cleaner concentrates and disinfectant concentrates for suitable cleaning milkstone. It is stated that the cleaner concentrate is characterized by the following components: 5 to 25%, preferably 10 to 20%, total alkalinity, calculated as NaOH; 1.5 to 7%, preferably 3 to 5%, inorganic phosphates, calculated as P₂O₅, 1 to 25%, preferably 3 to 12% of at least one chelating agent, where the chelating agent is selected from the group consisting of: NTA; EDTA; Gluconic acid; Phosphonic acids; N-(2-hydroxyethyl) iminodiacetic acid; 1,2,3,4-cyclopentanetetracar boric acid; Citric acid; O-carboxymethyl tartronic acid; O-carboxymethyloxy succinic acid; and salts of those substances. There is also taught a method for cleaning milking systems (dairy equipment) having the following steps: a) pre-rinse with return water, the recovered contains acidic disinfectant solution; b) cleaning with an alkaline cleaning solution; c) disinfecting with an acidic disinfectant solution; and d) collecting the used disinfectant solution in one return water tank.

U.S. Pat. No. 6,472,358 B1 teaches a sanitizing composition comprising at least one aliphatic short chain antimicrobially effective C5 to C14 fatty acid or mixture thereof, at least one carboxylic weak acid and a strong mineral acid which may be nitric or a mixture of nitric and phosphoric acids.

U.S. Pat. No. 4,414,128 teaches liquid detergent compositions, particularly for use as hard surface cleaners, comprising 1%-20% surfactant, 0.5%40% mono- or sesquiterpenes, and 0.5%-10% of a polar solvent having solubility in water of from 0.2% to 10%, preferably benzyl alcohol.

U.S. Pat. No. 5,759,440 teaches an aqueous solution of hydrogen peroxide allegedly stabilized by incorporation of a composition containing a mixture of an alkali metal pyrophosphate or alkaline earth metal pyrophosphate with a stabilizer belonging to the category of aminopolycarboxylic acids corresponding to the following general formula:

U.S. Pat. No. 6,316,399 teaches a cleaning composition including a terpene such as D-limonene or Orange oil and hydrogen peroxide or an alkaline stable peroxide in a surfactant based aqueous solution.

U.S. Pat. No. 6,767,881 teaches compositions that include: (a) a terpene compound; (b) a surfactant; and (c) an ethoxylated aryl alcohol.

U.S. Pat. No. 5,597,793A teaches a foam stabilizing composition which is used in conjunction with alkaline detergent products to produce a foam which is capable of clinging to vertical surfaces for extended time periods without breakdown or drying and which ultimately rinses freely with water. The foam stabilizing composition generally comprises a vinyl polymer emulsion. The invention also comprises a method of cleaning hard surfaces using the combination of the alkaline detergent product and the disclosed foam stabilizing composition.

US patent application number 2008/0119382A1 discloses a foamable composition comprising: a) at least one anionic surfactant chosen from a salt of an alkyl sulfate and a salt of an alkyl ether sulfate in an amount of about 0.01 to about 1% by weight of the composition; b) at least one glycol ether in an amount of about 0.1 to about 1.5% by weight of the composition; c) at least one alcohol in an amount of about 2 to about 6% by weight of the composition; and d) water. Also disclosed is a foamable composition comprising: a) at least one anionic surfactant chosen from a salt of an alkyl sulfate and a salt of an alkyl ether sulfate; b) at least one glycol ether; c) at least one alcohol; and d) water, wherein the composition has a run down time of greater than about 15 seconds on a vertical glass surface across a distance of 10 cm.

In light of the state of the art, there still exists a need for high pH compositions to perform CIP on industrial equipment, which can be used at lower temperature while still remaining effective. Moreover, a high pH composition that can clean both the organic soils and inorganic scales simultaneously would reduce the time of cleaning, thus reducing the cost of cleaning as well as the environmental impact of doing so. Preferably, it is also desirable to seek out compositions which accomplish the cleaning as efficiently (or ever more so) than currently used compositions but which offer a better HSE profile for people using such compositions.

In light of the prior art, while there are many available types of cleaning compositions, there is still a need for caustic composition which can provide effective cleaning of vessels from both the organic soils and inorganic scales simultaneously, said composition would preferably provide a high foaming effect but with a controlled duration so as to not be damaging to the steel to which they are exposed and would, in most preferable cases, provide an increased level of HSE for workers handling the compositions.

### SUMMARY OF THE INVENTION

According to an aspect of the present invention, there is provided a caustic (high alkaline) composition for use in washing tanks, pipes and associated ancillary equipment in industrial food and beverage factories such as those manufacturing juices and soft drinks, milk factories, frozen foods and other foods, and various food and beverage. Preferably, the present invention relates to a high foaming cleaning composition for caustic COP that can dissolve both organic soils and inorganic scales simultaneously.

According to a first aspect of the present invention, there is provided a caustic composition for cleaning apparatus, said composition comprising:
a caustic component;
a first low foaming anionic surfactant;
a second nonionic surfactant; and
a foam controlling agent comprising an amino acid.

According to a preferred embodiment of the present invention, the amino acid is selected from the group consisting of: lysine, arginine and histidine or a combination thereof. Preferably, the foam controlling agent is present in an amount of up to 10 wt %. More preferably, the foam controlling agent is present in an amount ranging from 0.2 to 6 wt %. Even more preferably, the foam controlling agent is present in an amount ranging from 1 to 4 wt %.

According to a preferred embodiment of the present invention, the first anionic surfactant comprises polycarboxylate.

According to a preferred embodiment of the present invention, the second nonionic surfactant comprises an alkyl polyglucoside.

Preferably, the composition has an advancing contact angle (θ_{A}) of less than 80 degrees and a receding contact angle (θ_{R}) of less than 30 degrees. Even more preferably, the composition has a surface tension (SFT) when measured using a Wilhelmy plate with a tensiometer of less than 40 mN/m. Even more preferably, the composition has a surface tension (SFT) when measured using a Wilhelmy plate with a tensiometer ranging between 25 and 35 mN/m.

Preferably, the caustic component is present in an amount ranging from 20 to 60 wt % of the total weight of the composition. More preferably, the caustic component is present in an amount ranging from 25 to 45 wt % of the total weight of the composition.

According to a preferred embodiment of the present invention, the foam controlling agent has an impact on one or more of the following: foam height; foam duration; and combinations thereof.

According to an aspect of the present invention, there is provided a method of cleaning industrial equipment while controlling the duration of a foam said method comprising the following:
providing said industrial equipment in need of cleaning, said industrial equipment selected from the group consisting of: a vessel, a tubing and a combination thereof;
providing a composition comprising:
   a caustic component;
   a first low foaming anionic surfactant;
   a second nonionic surfactant; and
   a foam controlling agent comprising an amino acid (such as lysine, arginine and histidine or a combination thereof);
      exposing the industrial equipment to the composition;
      foaming said composition for a period of time sufficient for the composition to be exposed to said industrial equipment so as to remove any contaminants present on the industrial equipment; and
      optionally, rinsing said industrial equipment.

According to an aspect of the present invention, there is provided a method for controlling the duration of a foam said method comprising the following:
providing a vessel or tubing in need of cleaning;
providing a composition comprising:
   a caustic component;
   a first low foaming anionic surfactant;
   a second nonionic surfactant; and
   a foam controlling agent comprising an amino acid (such as lysine, arginine and histidine or a combination thereof);
      exposing the vessel to the composition;
      foaming said composition for a period of time sufficient for the composition to be exposed to the vessels so as to remove any contaminants present on the vessel; and
      optionally, rinsing the vessel.

According to an aspect of the present invention, there is provided a use of a foam controlling agent to minimize the duration of a foam, said foam controlling agent comprising an amino acid (such as lysine).

According to an aspect of the present invention, there is provided a caustic composition for cleaning apparatus capable of dissolving both inorganic compounds and organic compounds, said composition comprising:
a caustic component;
a first low foaming anionic surfactant;
a second nonionic surfactant; and
a foam controlling agent comprising an amino acid.

According to an aspect of the present invention, there is provided caustic composition for cleaning apparatus capable of dissolving both inorganic compounds and organic compounds, said composition comprising:
a caustic component;
a first low foaming anionic surfactant;
a second nonionic surfactant; and
a foam controlling agent comprising an amino acid;
   wherein the foam lasts for a duration of time ranging from more than 5 minutes to less than 30 minutes.

According to a preferred embodiment of the present invention, the caustic composition can be used for cleaning by COP (cleaning-out-of-place) methods various types of equipment such as filling machines, sterilizers, heat treatment machines, and various containers such as pipes, containers, craters, and barrels. According to a preferred embodiment of the present invention, there is provided a high foaming caustic cleaning composition for caustic COP, where said composition can dissolve both the organic soils and inorganic scales simultaneously. According to another preferred embodiment of the present invention, there is provided a method of caustic COP.

According to a preferred embodiment of the present invention, the caustic component is selected from the group consisting of: sodium hydroxide; potassium hydroxide; sodium metasilicate; and combinations thereof. Preferably, the caustic component is sodium hydroxide.

According to a preferred embodiment of the present invention, the amino acid is selected from the group consisting of: basic amino acids. Preferably, the basic amino acids are selected from the group consisting of: lysine; histidine; arginine; glycine salts and hydrates thereof as well as combinations thereof. More preferably, the amino acid is lysine monohydrochloride.

According to a preferred embodiment of the present invention, the low foaming anionic surfactant is a multifunctional polycarboxylate anionic surfactant. More preferably, the low foaming anionic surfactant is Plurafac® CS-10.

According to a preferred embodiment of the present invention, the nonionic surfactant Triton® BG-10 is one of the two surfactants present. Preferably, it is present with Plurafac® CS-10.

According to another preferred embodiment of the present invention, the low foaming anionic surfactant is a polycarboxylated anionic surfactant. One example of this type of surfactant is anionic Plurafac® CS-10. Plurafac CS-10® is known as a low foaming anionic surfactant with high temperature stability and great caustic solubility (up to 35% NaOH and 50% KOH solution). It is highly recommended for bleach free alkaline CIP cleaners or any low foaming formulation. Plurafac® CS-10 can sequester calcium and magnesium ions which is the functionality of the chelating agents. This ability to chelate makes this surfactant suitable for use in the presence of hard water.

According to a preferred embodiment of the present invention, the caustic component is present in a concentration ranging from 30-60 wt % of the total weight of the composition when the caustic component is 50% NaOH, for example. This leads to final caustic concentrations ranging from 15 to 30 wt %. More preferably, the caustic component makes up 60 wt % of the total weight of the composition. Preferably, a solution of 50% sodium hydroxide will make up 60 wt % of the total alkaline cleaning composition.

According to a preferred embodiment of the present invention, the first surfactant component is present in a concentration ranging from 2 to 20 wt % of the total weight of the composition. More preferably, the surfactant component makes up 2 to 10 wt % of the total weight of the composition. The first surfactant can sequester calcium and magnesium ions eliminating the need for chelating agents and also can dissolve calcium and magnesium scales and other scales.

According to a preferred embodiment of the present invention, the second surfactant component is a nonionic surfactant and is present in a concentration ranging from 2 to 20 wt % of the total weight of the composition. More preferably, the surfactant component makes up 2 to 10 wt % of the total weight of the composition.

According to a preferred embodiment of the present invention, the amino acid component is present in a concentration ranging up to 10 wt % of the total weight of the composition. More preferably, the amino acid component makes up 0.5 to 6 wt % of the total weight of the composition. Amino acids can sequester calcium and magnesium ions eliminating the need for chelating agents.

The rest of the composition is made up with water. Examples of water which is used in the manufacturing of the caustic cleaning composition according to the present invention include pure water, ion exchange water, soft water, distilled water, and tap water. These may be used alone or in combination of two or more. Of these, tap water and ion-exchanged water are preferably used from the viewpoints of economy and storage stability. “Water” is the sum of water contained in the form of crystal water or aqueous solution derived from each component constituting the cleaning composition of the present invention and water added from the outside, and the entire composition when water is added is 100%.

The caustic COP cleaning composition of the present invention has been made for use in various industrial settings including, but not limited to, breweries, beverage factory such as juice and soft drink, milk factory, frozen food/retort food; cleaning of tanks, pipes, etc. in various food manufacturing factories; etc. More specifically, various equipment, various equipment such as filling machines, sterilizers, heat treatment machines, and machines for these pipes, containers, craters, barrels, etc. COP operations can also be done in machine sections which are not in contact with food or beverage such as, but not limited to heat exchangers, boilers, heating pipes, etc.

According to a preferred embodiment of the present invention is a COP cleaning method, wherein the caustic COP cleaning composition is diluted with water or hot water. Preferably, the dilution can be to a concentration of 0.2 to 30 wt % of the stock solution (or stock composition).

The caustic COP cleaning compositions according to preferred embodiments of the present invention (hereinafter sometimes referred to as “alkaline or caustic cleaning composition”) are particularly suitable for cleaning organic and inorganic soils, high foaming, rubber corrosion resistance, low temperature and high temperature. Excellent storage stability, especially excellent storage stability even at a low temperature of −5° C. or lower, and excellent storage stability even at a high temperature of 40° C. or higher.

### BRIEF DESCRIPTION OF THE FIGURES

Features and advantages of embodiments of the present application will become apparent from the following detailed description and the appended figures, in which:

FIGS. 1a and 1b are graphical depictions of foam height and liquid height for the CSR-F-1D to 3D and compared to CSR-F-0D over time;

FIGS. 2a and 2b are graphical depictions of foam height and liquid height for the CSR-F-4D to 6D and compared to CSR-F-0D over time;

FIG. 3a is a graphical depiction of foam height for the CSR-F-15D to 18D and compared to CSR-F-0D over time;

FIG. 3b is a graphical depiction of liquid height for the CSR-F-15D to 18D and compared to CSR-F-0D over time;

FIG. 4a is a photograph and 4b is an infrared map of column of the foam for CSR-F-18D;

FIG. 5a is a graphical depiction of foam height for the CSR-F-19 to CSR-F-23 compared to CSR-F-17 over time.

FIG. 5b is a graphical depiction of liquid height for the CSR-F-19 to CSR-F-23 compared to CSR-F-17 over time.

FIG. 6 is a photograph of the samples without Lysine after 2 weeks showing separation; and

FIG. 7 is a photograph of the samples with Lysine after 2 weeks.

### DETAILED DESCRIPTION OF THE INVENTION

According to a preferred embodiment of the present invention, there is provided a caustic composition for cleaning apparatus, said composition comprising:
a caustic component;
a first low foaming anionic surfactant;
a second nonionic surfactant; and
a foam controlling agent comprising an amino acid.

Preferably, the amino acid from the foam controlling agent is selected from the group consisting of: lysine, arginine and histidine or a combination thereof.

According to a preferred embodiment of the present invention, the caustic component is selected from the group consisting of: potassium hydroxide; sodium hydroxide; lithium hydroxide; cesium hydroxide; rubidium hydroxide and combinations thereof; and a modified caustic composition comprises one of the above mentioned caustic component (potassium hydroxide; sodium hydroxide; lithium hydroxide; cesium hydroxide; rubidium hydroxide) in combination with a causticity modifying additive, wherein said causticity modifying additive can provide an extended (more methodical and linear) buffering effect to the caustic composition as well as greatly lowering the freeze point and providing an increased level of dermal protection. Examples of such modified caustic composition can be found in Canadian patent applications CA 3,023,705; CA 3,023,613; CA 3,023,610; and CA 3,023,604.

According to a preferred embodiment of the present invention, the modified caustic composition comprises:
a caustic component selected from the group consisting of: potassium hydroxide; sodium hydroxide; lithium hydroxide; cesium hydroxide; rubidium hydroxide and combinations thereof; and
a causticity modifying additive selected from the group consisting of: taurine; gamma-aminobutyric acid; aminovaleric acid; aminocaproic acid; aminocapric acid; sulfopyruvic acid; sulfobutanoic acid; sulfopentanoic acid; sulfohexanoic acid; phosphonium zwitterions with either a sulfonic acid or carboxylic acid group selected from the group consisting of: 2-hydroxyethyl triphenylphosphonium sulfate zwitterion; (Z-hydroxyethyl)trimethylphosphonium sulfate zwitterion (M.W. of 200.2); (3-hydroxy-n-propyl)triphenylphosphonium sulfate zwitterion (M.W. of 400.4); (2-hydroxy-1-methyl-n-propyl) trimethylphosphonium sulfate zwitterion (M.W. of 228.3); (3-hydroxy-n-propyl)tri-n-butylphosphonium sulfate zwitterion (M.W. of 340.5); (Z-hydroxy-1,2-diphenylethyl)-triethylphosphonium sulfate zwitterion (M.W. of 394.5); (3-hydroxy-n-propyl)dimethylphenylphosphonium sulfate zwitterion (M.W. of 276.3); (Z-hydroxy-n-butyl)triisopropylphosphonium sulfate zwitterion (M.W. of 312.4); (3-hydroxy-1-methyl-n-butyl)-n-butyl-di-n-propylphosphonium sulfate zwitterion (M.W. of 340.5); and (3-hydroxy-2-ethyl-4 methyl-n-pentyl)-n-butyldiphenylphosphonium sulfate zwitterion (M.W. of 450.6); -phophoric acid ester group with an amine group; and phosphonic and phosphinic acids and their esters with an amine group.

According to a preferred embodiment of the present invention, the caustic component is selected from the group consisting of: potassium hydroxide; sodium hydroxide; and combinations thereof. Preferably, the caustic component is sodium hydroxide. Preferably, the caustic component is present in a concentration of up to 40 wt % of the modified caustic composition. Also preferably, the caustic component is present in a concentration ranging from 5 to 40 wt % of the modified caustic composition. More preferably, the caustic component is present in a concentration ranging from 10 to 30 wt % of the modified caustic composition. Most preferably, the caustic component is present in a concentration ranging from 15 to 25 wt % of the modified caustic composition. According to a preferred embodiment of the present invention, the caustic component is present in a concentration of 25 wt % of the modified caustic composition. According to a preferred embodiment of the present invention, the causticity modifying additive is present in a concentration ranging from 4 wt % to 25 wt % of the composition. Preferably, the causticity modifying additive is present in a concentration ranging from 5 wt % to 15 wt % of the composition. More preferably, the causticity modifying additive is present in a concentration ranging from 5 wt % to 10 wt % of the composition.

According to another preferred embodiment of the present invention, the modified caustic composition comprises:
a caustic component selected from the group consisting of: potassium hydroxide; sodium hydroxide; lithium hydroxide; cesium hydroxide; rubidium hydroxide and combinations thereof; and
a causticity modifying additive selected from the group consisting of: monoethanolamine; diethanolamine; triethanolamine; aminomethyl propanol; propanolamine; dime thylethanolamine; and N-methylethanolamine. Preferably, the additive is monoethanolamine.

According to a preferred embodiment of the present invention, the caustic component is selected from the group consisting of: potassium hydroxide; sodium hydroxide; and combinations thereof. Preferably, the caustic component is sodium hydroxide. Preferably, the caustic component is present in a concentration of up to 40 wt % of the modified caustic composition. Also preferably, the caustic component is present in a concentration ranging from 5 to 40 wt % of the modified caustic composition. More preferably, the caustic component is present in a concentration ranging from 10 to 30 wt % of the modified caustic composition. Most preferably, the caustic component is present in a concentration ranging from 15 to 25 wt % of the modified caustic composition. According to a preferred embodiment of the present invention, the caustic component is present in a concentration of 25 wt % of the modified caustic composition. According to a preferred embodiment of the present invention, the causticity modifying additive is present in a concentration ranging from 4 wt % to 25 wt % of the composition. Preferably, the causticity modifying additive is present in a concentration ranging from 5 wt % to 15 wt % of the composition. More preferably, the causticity modifying additive is present in a concentration ranging from 5 wt % to 10 wt % of the composition.

According to yet another preferred embodiment of the present invention, the modified caustic composition comprises:
a caustic component selected from the group consisting of: potassium hydroxide; sodium hydroxide; lithium hydroxide; cesium hydroxide; rubidium hydroxide and combinations thereof; and
a causticity modifying additive which is glycine.

According to a preferred embodiment of the present invention, the caustic component is selected from the group consisting of: potassium hydroxide; sodium hydroxide; and combinations thereof. Preferably, the caustic component is sodium hydroxide. Preferably, the caustic component is present in a concentration of up to 40 wt % of the modified caustic composition. Also preferably, the caustic component is present in a concentration ranging from 5 to 40 wt % of the modified caustic composition. More preferably, the caustic component is present in a concentration ranging from 10 to 30 wt % of the modified caustic composition. Most preferably, the caustic component is present in a concentration ranging from 15 to 25 wt % of the modified caustic composition. According to a preferred embodiment of the present invention, the caustic component is present in a concentration of 25 wt % of the modified caustic composition. According to a preferred embodiment of the present invention, the causticity modifying additive is present in a concentration ranging from 4 wt % to 25 wt % of the composition. Preferably, the causticity modifying additive is present in a concentration ranging from 5 wt % to 15 wt % of the composition. More preferably, the causticity modifying additive is present in a concentration ranging from 5 wt % to 10 wt % of the composition.

According to yet another preferred embodiment of the present invention, the modified caustic composition comprises:
a caustic component selected from the group consisting of: potassium hydroxide; sodium hydroxide; lithium hydroxide; cesium hydroxide; rubidium hydroxide and combinations thereof; and
a causticity modifying additive selected from the group consisting of: lysine monohydrochloride; threonine; methionine; glutamic acid; and taurine. Preferably, the causticity modifying additive is lysine monohydrochloride or taurine. More preferably, the causticity modifying additive is lysine monohydrochloride.

According to a preferred embodiment of the present invention, the caustic component is selected from the group consisting of: potassium hydroxide; sodium hydroxide; and combinations thereof. Preferably, the caustic component is sodium hydroxide. Preferably, the caustic component is present in a concentration of up to 40 wt % of the modified caustic composition. Also preferably, the caustic component is present in a concentration ranging from 5 to 40 wt % of the modified caustic composition. More preferably, the caustic component is present in a concentration ranging from 10 to 30 wt % of the modified caustic composition. Most preferably, the caustic component is present in a concentration ranging from 15 to 25 wt % of the modified caustic composition. According to a preferred embodiment of the present invention, the caustic component is present in a concentration of 25 wt % of the modified caustic composition. According to a preferred embodiment of the present invention, the causticity modifying additive is present in a concentration ranging from 4 wt % to 25 wt % of the composition. Preferably, the causticity modifying additive is present in a concentration ranging from 5 wt % to 15 wt % of the composition. More preferably, the causticity modifying additive is present in a concentration ranging from 5 wt % to 10 wt % of the composition.

Plurafac® CS-10 (BASF) is a multifunctional polycarboxylate low-foaming anionic surfactant that is provided as 50% aqueous solution. It can sequester calcium and magnesium ions, emulsify oil, and tolerate silicates and phosphates. It is soluble in highly caustic solutions (35% NaOH). However, like most anionic surfactants, it is not soluble in highly acidic solutions (14.1% HCl).

According to another preferred embodiment of the present invention, the surfactant is anionic Plurafac® CS-10. Plurafac CS-10® is known as a low foaming anionic surfactant with high temperature stability and great caustic solubility (up to 35% NaOH and 50% KOH solution). It is recommended for use in bleach free alkaline CIP cleaners or any low foaming formulation. Plurafac® CS-10 can sequester calcium and magnesium ions which is the functionality of the chelating agents, which makes compositions containing such suitable for use with hard water.

According to a preferred embodiment of the present invention, the nonionic surfactant is Lutensol® XL 80. It is an alkyl polyethylene glycol ether made from a C10-Guerbet Alcohol and ethylene oxide. It is also said to contain also higher alkylene oxide in small amounts. Lutensol® XL 80 is a nonionic branched nonionic surfactant with 8 degree of ethoxylation and 100% concentration. It is an alkyl polyethylene glycol ethers made from a C10-Guerbet alcohol and alkylene oxides. It is a clear to cloudy liquid, at room temperature, but becomes clear at 50° C.

Triton® BG-10 is a nonionic surfactant intended for use in metal cleaners, paint strippers, and highly alkaline detergents. Its manufacturer (DOW) states that it provides good detergency and wetting properties, and is capable of producing a moderate to highly stable foam. It is made of alkyl polyglucosides and is a stated to be a readily biodegradable material.

### Examples

A concentrate solution of Triton® BG-10 or Plurafac® CS-10 (7 wt %) in NaOH, 50% (70 wt %) was prepared. Triton® BG-10 is very soluble in 70 wt % NaOH, 50% and forms a clear dark brown solution. On the other hand, Plurafac® CS-10 is not very soluble in 70 wt % NaOH, 50% and forms a dense dark orange solution. However, when the stock solution of Plurafac® CS-10 is diluted and Triton® BG-10 is added, it forms a clear dark brown solution. According to a preferred embodiment of the present invention, it is desirable to add Triton® BG-10 first before Plurafac® CS-10.

TABLE 1
Stock solution of high alkaline Triton BG-10
and Plurafac ® CS-10 solutions

| | 7 wt % Triton ® BG-10 | | 7 wt % Plurafac ® CS-10 | |
|---|---|---|---|---|
| | wt % | g | wt % | g |
| NaOH, 50% | 70 | 280 | 70 | 280 |
| Triton ® BG 10 | 7 | 28 | 7 | 14 |
| Water | ca to 100 | 92 | ca to 100 | 106 |
| Total | | 400 | | 400 |

Formulations

The stock solutions were then used to make formulations with 60% NaOH, 50% and 6 or 3 wt % Triton BG-10 with the addition of other surfactants such as Basocorr® 2005, Plurafac® CS-10, 50%, Lutensol® XL 80, Lysine monohydrochloride. To prepare a 20 mL composition, a 17.14 g aliquot from the stock solution was mixed with other surfactants.

Formulations Dilution

In order to perform the surface tension, dynamic contact angle, and foamability tests, the formulations were diluted to a concentration of equivalent 1 wt % NaOH by adding 3.33 g aliquot of formulation to 96.67 g of water.

Surface Tension

Wilhelmy Plate method was used to measure the surface tension of the diluted formulations using a Kruss® 100C force tensiometer.

Dynamic Contact Angle

Dynamic contact angle measurements were conducted using the Wilhelmy plate method with a Kruss® 100C force tensiometer. A parafilm plate was used as a hydrophobic surface to measure the efficiency of the formulations in reducing the contact angles. The advancing and receding contact angles (θ_{A} and θ_{R}) were measured. They are indicative of how efficient the formulation can change the wettability of a hydrophobic surface to be more water-wet for easier cleaning of the surfaces. The advancing angles (θ_{A}) is always higher than the receding contact angles (θ_{R}) as the plate advancing in the fluid dry. But while receding, the molecules were already oriented at the surface.

Dynamic Foam Analyzer DFA100C from Kruss was used to measure the foamability and foam stability of the different formulations made. DFA100C is equipped with 40 mm internal diameter glass column with a frit glass of 16-40 μm pore size (FL4503-G3). The column is fixed in between infrared source and receiver to automatically measure the height of the foam overtime. 50 mL of formulations was placed inside the column with a syringe to prevent any foaming during this step. Then, air is subsequently injected through the frit glass filter at rate of 0.3 mL/min for 20 seconds. Foamability was calculated based on the maximum height during foaming. Foam stability was measured based on the foam height after 5, 15, and 20 minutes. For the best formulations, extended foam stability was conducted to measure the decay half-life time (τ_{1/2}).

Formulations with 6 wt % Triton BG-10 with Different Concentrations of Plurafac CS-10 or Basocorr 2005

Formulations containing a constant concentration of Triton® BG-10 (6 wt %) and NaOH, 50% (60 wt %) were prepared by diluting the 7 wt % BG-10 stock solution and then Basocorr® 2005 or Plurafac® CS-10, 50% and water were added.

Table 2 presents the composition of the formulations of NaOH, 50% (60%) and BG-10 (6%) with different concentrations of Basocorr® 2005. All of the formulations were clear 1-phase solutions.

Table 3 presents the composition of the formulations of NaOH, 50% (60%) and BG-10 (6%) with different concentrations of Plurafac® CS-10, 50%. All of the formulation were clear 1-phase solutions.

Table 4 shows that these diluted formulations significantly decreased the surface tension and the advancing (θ_{A}) and receding (θ_{R}) contact angles. This would allow an efficient penetration of any deposited soil and effective cleaning of the solid surfaces.

TABLE 2
Formulations of 50% NaOH (60% concentration) and
BG-10 (6%) with Basocorr ® 2005

| | CSR-F-0 | | CSR-F-1 | | CSR-F-2 | | CSR-F-3 | |
|---|---|---|---|---|---|---|---|---|
| | wt % | g | wt % | g | wt % | g | wt % | g |
| 7% Stock | | 17.14 | | 17.14 | | 17.14 | | 17.14 |
| Aliquot (g) | | | | | | | | |
| Basocorr 2005 | 0 | 0 | 1 | 0.2 | 2 | 0.4 | 3 | 0.6 |
| Water (Make | ca | 2.86 | ca | 2.66 | ca | 2.46 | ca | 2.26 |
| up) | | | | | | | | |
| Total | | 20.00 | | 20.00 | | 20.00 | | 20.00 |
| Soluble | | Y | | Y | | Y | | Y |

TABLE 3
Formulations of 50% NaOH (60% concentration) and 50%
BG-10 (6%) with Plurafac ® CS-10

| | CSR-F-4 | | CSR-F-5 | | CSR-F-6 | |
|---|---|---|---|---|---|---|
| | wt % | g | wt % | g | wt % | g |
| 7% Stock Aliquot (g) | | 17.14 | | 17.14 | | 17.14 |
| Plurafac CS-10, 50% | 1 | 0.2 | 2 | 0.4 | 3 | 0.6 |
| Water (Make up) | ca | 2.66 | ca | 2.46 | ca | 2.26 |
| Total | | 20.00 | | 20.00 | | 20.00 |
| Soluble | | Y | | Y | | Y |

TABLE 4
Measurements for the diluted samples of formulations CSR-F-0 to CSR-F-6

| | CSR-F-0D | CSR-F-1D | CSR-F-2D | CSR-F-3D | CSR-F-4D | CSR-F-5D | CSR-F-6D |
|---|---|---|---|---|---|---|---|
| pH | | | | | | | |
| RI (nD) | 1.336 | 1.3361 | 1.3361 | 1.3361 | 1.3361 | 1.3361 | 1.3361 |
| Density (g/mL) | 1.00976 | 1.00963 | 1.00965 | 1.00962 | 1.00967 | 1.00974 | 1.00986 |
| SG | 1.01158 | 1.01144 | 1.01147 | 1.01144 | 1.01148 | 1.01156 | 1.01168 |
| SFT | 26.48 | 26.33 | 26.33 | 26.24 | 26.56 | 26.56 | 26.71 |
| Θ_{A} | 40.01 | 42.65 | 39.98 | 38.08 | 39.96 | 41 | 41.66 |
| θ_{R} | 11.11 | 8.91 | 8.1 | 6.64 | 8.57 | 8.68 | 7.9 |

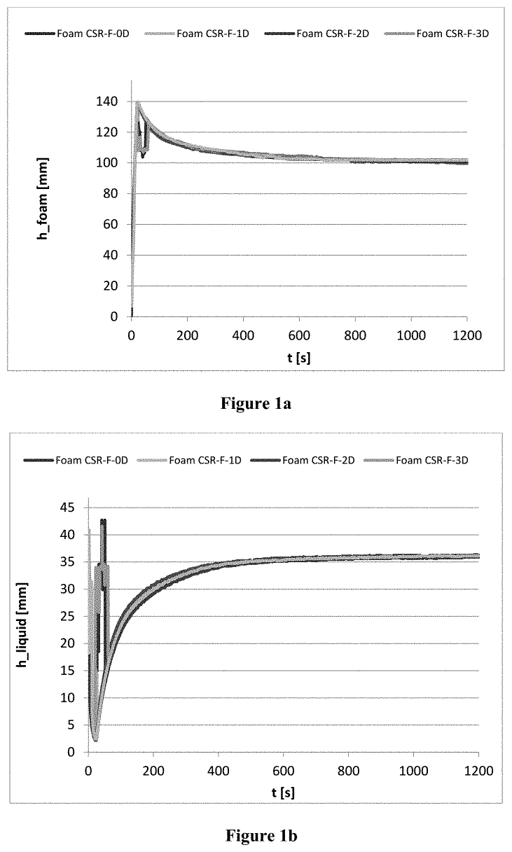

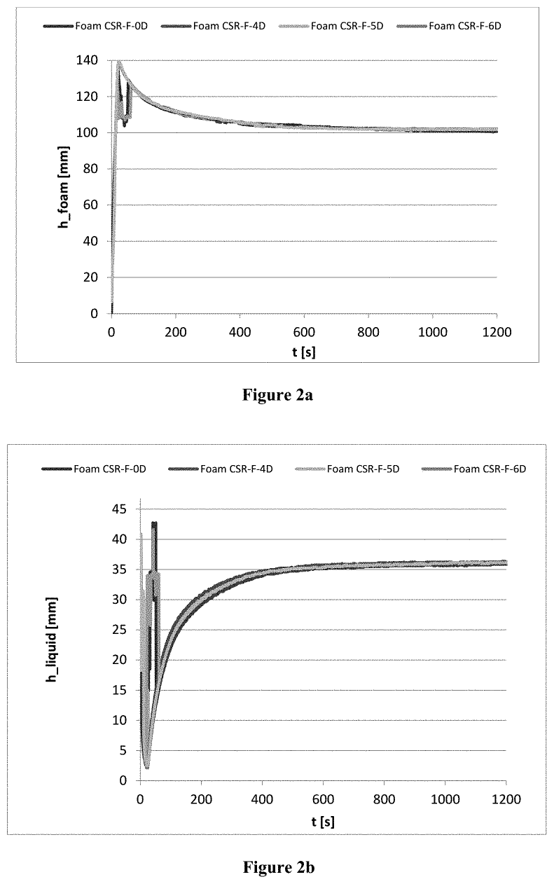

FIGS. 1 and 2 present the foam height and liquid height for the CSR-F-1D to 6D over time. All the samples did form a good foam that is stable for long time. There was no significant difference between all the samples regardless of the concentration of Basocorr® 2005 or Plurafac® CS-10 up to 3 wt % in the original formulations.

Another set of compositions made with adding both Basocorr® 2005 and Plurafac® CS-10 together into NaOH, 50% (60%) and BG-10 (6%). However, these formulations formed a solid floc that were not miscible in the solution and hence they were discarded.

Formulations with 6 wt % Plurafac CS-10 with Different Concentrations of Triton BG-10

A number of formulations containing a constant concentration of Plurafac® CS-10 (6 wt %) and NaOH, 50% (60 wt %) were prepared by diluting the 7 wt % Plurafac® CS-10 stock solution. To this stock solution, Triton® BG-10 and water were added.

Table 5 presents the composition of the formulations of NaOH, 50% (60%) and Plurafac® CS-10 (6%) with different concentrations of Triton BG-10. All of the formulations were clear 1-phase solutions.

Table 6 shows that these diluted formulations significantly decreased the surface tension and the advancing (θ_{A}) and receding (θ_{R}) contact angles. This would allow an efficient penetration of any deposited soil and effective cleaning of the solid surfaces. However, the contact angle of the formulations where Triton® BG-10 is the dominant surfactant have lower contact angles compared to formulations with dominant Plurafac® CS-10.

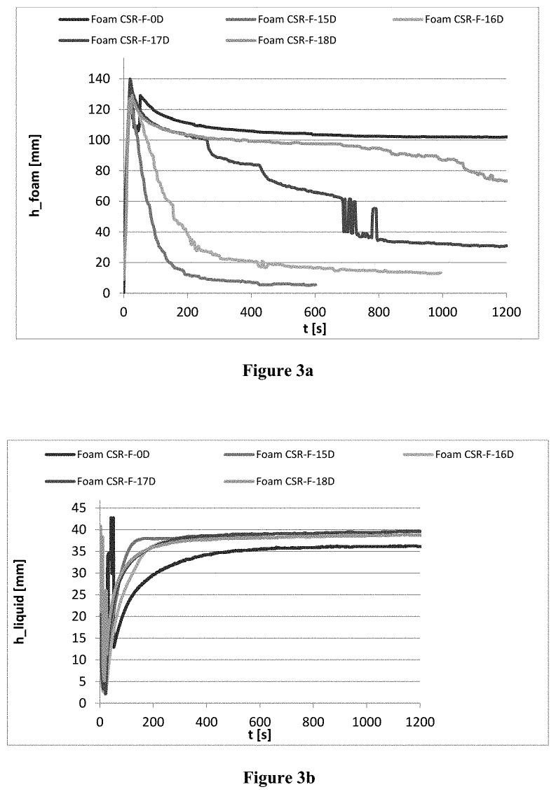

FIG. 3 presents the foam data for these diluted formulations. It is evident that Plurafac® CS-10 is a very low foaming surfactant and the foam life can be extended by adding Triton® BG-10 at different concentrations. This is particularly desirable for open vessel cleaners which require good foamability in order to clean the walls of such vessels. However, as important as good foamability is, it is also desirable that the foam dies within a reasonable amount of time, otherwise it becomes problematic as it slows down the cleaning process and consequently, overall production.

While formulations with dominant Triton® BG-10 provide a very stable foam (upon application) for a long time even in the presence of Plurafac® CS-10, the formulations where Plurafac® CS-10 is the dominant surfactant have less than 20 minutes half-life.

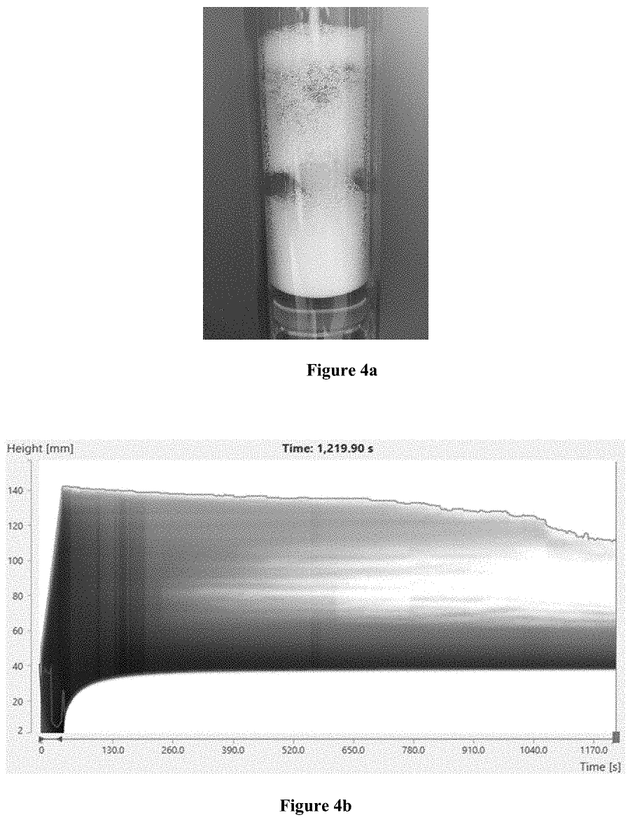

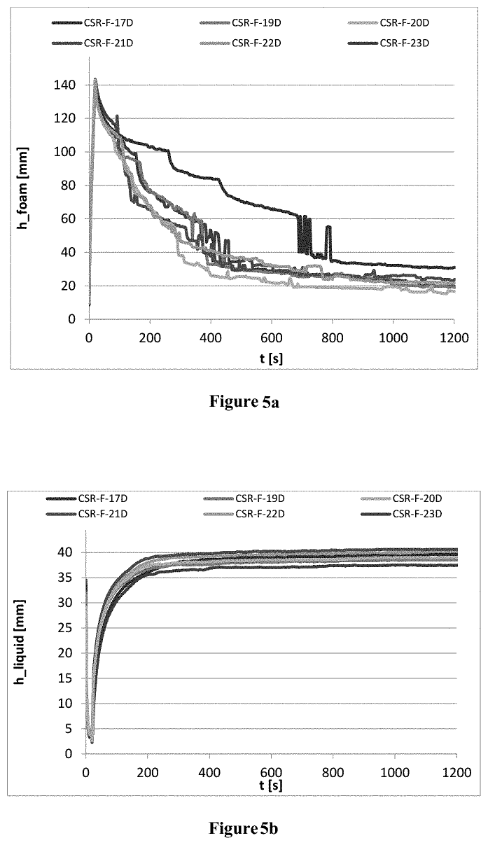

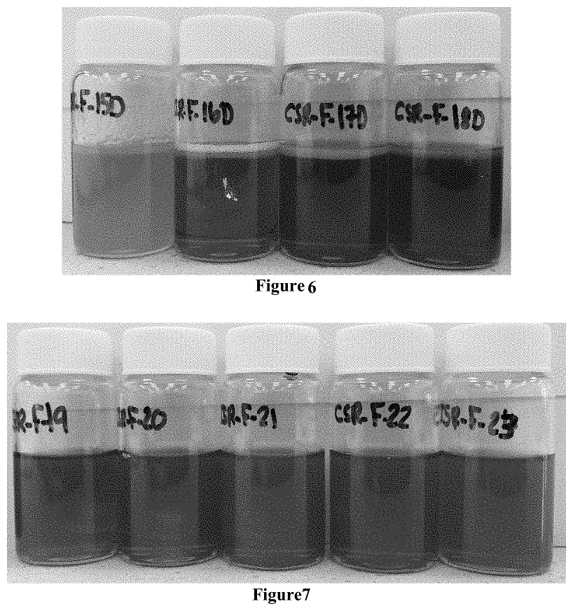

FIG. 4 presents a photograph of the foam for CSR-F-18D that showing the foam collapsing from within. The infrared map of the foam column shows a significant collapsing of the foam from within represented by the white are between 60- and 120-mm height.

TABLE 5
Formulations of NaOH, 50% (60%) and Plurafac ®
CS-10 (6%) with Triton ® BG-10

| | CSR-F-15 | | CSR-F-16 | | CSR-F-17 | | CSR-F-18 | |
|---|---|---|---|---|---|---|---|---|
| | wt % | g | wt % | g | wt % | g | wt % | g |
| 7% Stock | | 17.14 | | 17.14 | | 17.14 | | 17.14 |
| Aliquot (g) | | | | | | | | |
| Triton ® | 0 | 0 | 1 | 0.2 | 2 | 0.4 | 3 | 0.6 |
| BG-10 | | | | | | | | |
| Water (Make | ca | 2.86 | ca | 2.66 | ca | 2.46 | ca | 2.26 |
| up) | | | | | | | | |
| Total | | 20.00 | | 20.00 | | 20.00 | | 20.00 |
| Soluble | | Y | | Y | | Y | | Y |

TABLE 6
Measurements for the diluted samples
of formulations CSR-F-15 to CSR-F-18

| | CSR-F-15D | CSR-F-16D | CSR-F-17D | CSR-F-18D |
|---|---|---|---|---|
| SFT | 29.39 | 31.69 | 30.47 | 29.24 |
| θ_{A} | 64.26 | 70.22 | 65.32 | 60.71 |
| θ_{R} | 29.29 | 36.86 | 30.05 | 20.53 |

Experiment with Foam Controlling Component

A set of samples containing 6 wt % Plurafac® CS-10, 2 wt % Triton BG-10 with different concentrations of lysine was prepared to study the effect of Lysine on the foam stability. The samples were prepared by dissolving lysine monohydrochloride first in NaOH and then adding Triton® BG-10 followed by Plurafac® CS-10. All of the samples were clear solution of a dark brown color. The formulation of the compositions prepared for this series of experiment is found on Table 7.

TABLE 7
Compositions with 6 wt % Plurafac ® CS-10, 2 wt % Triton ® BG-10
with Different concentrations of lysine

| | CSR-F-17 | | CSR-F-19 | | CSR-F-20 | | CSR-F-21 | | CSR-F-22 | | CSR-F-23 | |
|---|---|---|---|---|---|---|---|---|---|---|---|---|
| | wt % | g | wt % | g | wt % | g | wt % | g | wt % | g | wt % | g |
| NaOH, 50% | 60 | 12 | 60 | 12 | 60 | 12 | 60 | 12 | 60 | 12 | 60 | 12 |
| Plurafac ® CS-10 | 6 | 1.2 | 6 | 1.2 | 6 | 1.2 | 6 | 1.2 | 6 | 1.2 | 6 | 1.2 |
| Triton ® BG-10 | 2 | 0.4 | 2 | 0.4 | 2 | 0.4 | 2 | 0.4 | 2 | 0.4 | 2 | 0.4 |
| Lysine | 0 | 0 | 0.5 | 0.1 | 1 | 0.2 | 2 | 0.4 | 4 | 0.8 | 6 | 1.2 |
| Water (Make up) | | 6.4 | | 6.3 | | 6.2 | | 6 | | 5.6 | | 5.2 |
| Total | | 20 | | 20 | | 20 | | 20 | | 20 | | 20 |

| | | | | | | |
|---|---|---|---|---|---|---|
| Soluble | Y | Y | Y | Y | Y | Y |

Interestingly, the addition of lysine accelerates the foam decay compared to the cases when it is absent. However, the presence of lysine did not affect the foamability of the solution. The foam remaining after 20 minutes is low for the formulations containing lysine. Also, the presence of lysine slightly decreased the advancing and receding contact angles compared to the composition without lysine. For good foamability, height target is 120-150 mm. The duration of a short-lasting foam is expected to reach 10 mm in less than 5 minutes. On the other hand, long-lasting foams decay more slowly and may take days to fully decay.

According to a preferred embodiment of the present invention, the presence of an amino acid such as lysine allows to control the foam lifetime and deliver customized solutions for specific applications.

Moreover, lysine improves the stability of the formation. The formulations without lysine showed some separation after two weeks. However, the formulations containing lysine were stable and no separation was observed in any of the samples for a period of at least 2 months. FIG. 8 is a photograph of the samples without lysine after 2 weeks showing phase separation. FIG. 9 is a photograph of the samples with lysine after 2 weeks.

Table 8 shows that these diluted formulations significantly decreased the surface tension and the advancing (θ_{A}) and receding (θ_{R}) contact angles. This would allow an efficient penetration of any deposited soil and effective cleaning of the solid surfaces.

TABLE 8
Measurements for the diluted samples of formulations
CSR-F-19 to CSR-F-23 compared to CSR-F-17

| | CSR- | CSR- | CSR- | CSR- | CSR- | CSR- |
|---|---|---|---|---|---|---|
| | F-17 | F-19 | F-20 | F-21 | F-22 | F-23 |
| SFT | 30.47 | 30.07 | 30.13 | 30.04 | 30.06 | 28.83 |
| θ_{A} | 65.32 | 62.61 | 62.09 | 61.35 | 59.76 | 61.53 |
| θ_{R} | 30.05 | 24.92 | 26.16 | 26.1 | 26.98 | 22.03 |

For open vessel cleaning in the food and beverage plants, the formulations with shorter foam life are more desirable. Formulations with high reduction of contact angles and controlled foam life were developed for hard surface cleaning using a blend of high-foam nonionic surfactant and low-foam anionic surfactant. The low-foam anionic surfactant also has the functionality of a chelating agent to sequester multivalent ions from hard water. The use of an amino acid such as lysine allows one to control the foam life-time and deliver customized solutions for specific applications. A foam controlling agent comprising an amino acid, such as lysine, accelerates the foam decay compared to compositions which do not contain it. Advantageously, lysine does not affect the foamability of the compositions. The foam remaining after 20 minutes is low for the case that contain lysine. Also, the presence of lysine slightly decreased the advancing and receding contact angles compared to the compositions where lysine was not present.

Other components may also be added to the cleaning solution of the present invention to add a variety of properties or characteristics, as desired. For instance, additives may include colorants, fragrance enhancers, anionic or nonionic surfactants, corrosion inhibitors, defoamers, pH stabilizers, stabilizing agents, or other additives that would be known by one of ordinary skill in the art with the present disclosure before them.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. A caustic composition for cleaning apparatus, said composition comprising:
a caustic component;
a first low foaming anionic surfactant;
a second nonionic surfactant; and
a foam controlling agent comprising an amino acid.

2. The composition according to claim 1, where the amino acid is selected from the group consisting of: lysine, arginine and histidine or a combination thereof.

3. The composition according to claim 1, where the foam controlling agent is present in an amount of up to 10 wt %.

4. The composition according to claim 1, where the foam controlling agent is present in an amount ranging from 0.2 to 6 wt %.

5. The composition according to claim 1, where the foam controlling agent is present in an amount ranging from 1 to 4 wt %.

6. The composition according to claim 1, where the first low foaming anionic surfactant comprises a polycarboxylate.

7. The composition according to claim 1, where the second nonionic surfactant comprises an alkyl polyglucoside.

8. The composition according to claim 1, wherein said composition has an advancing contact angle (θ_{A}) of less than 80 degrees and a receding contact angle (θ_{R}) of less than 30 degrees.

9. The composition according to claim 1, wherein said composition has a surface tension (SFT) when measured using a Wilhelmy plate with a tensiometer of less than 40 mN/m.

10. The composition according to claim 1, wherein said composition has a surface tension (SFT) when measured using a Wilhelmy plate with a tensiometer ranging between 25 and 35 mN/m.

11. The composition according to claim 1, wherein said caustic component is present in an amount ranging from 20 to 60 wt % of the total weight of the composition.

12. The composition according to claim 1, wherein said caustic component is present in an amount ranging from 25 to 45 wt % of the total weight of the composition.

13. The composition according to claim 1, wherein the foam controlling agent has an impact on one or more of the following: foam height; foam duration; and combinations thereof.

14. The composition according to claim 1, wherein the caustic component is selected from the group consisting of potassium hydroxide; sodium hydroxide; lithium hydroxide; cesium hydroxide; rubidium hydroxide; and a modified caustic composition comprising said caustic component in combination with a causticity modifying additive.

15. The composition according to claim 1, wherein the caustic component is sodium hydroxide.

16. The composition according to claim 1, wherein said foam controlling agent comprising an amino acid selected from the group consisting of: lysine; arginine; histidine; and a combination thereof.

17. Method of cleaning industrial equipment while controlling the duration of a foam said method comprising the following:
providing said industrial equipment in need of cleaning, said industrial equipment selected from the group consisting of: a vessel, a tubing and a combination thereof;
providing a composition comprising:
a caustic component;
a first low foaming anionic surfactant;
a second nonionic surfactant; and
a foam controlling agent comprising an amino acid (such as lysine, arginine and histidine or a combination thereof);
exposing the industrial equipment to the composition;
foaming said composition for a period of time sufficient for the composition to be exposed to said industrial equipment so as to remove any contaminants present on the industrial equipment; and
optionally, rinsing said industrial equipment.

18. Use of a foam controlling agent to minimize the duration of a foam, said foam controlling agent comprising an amino acid selected from the group consisting of: lysine; arginine; histidine; and a combination thereof.

19. Use according to claim 17 of a foam controlling agent to minimize the duration of a foam, said foam controlling agent is lysine.

20. A composition according to claim 18, wherein the foam lasts for a duration of time ranging from more than 5 minutes to less than 30 minutes.
